(19) United States
(12) Patent Application Publication
(10) Pub. No.: US 2026/0179109 A1
(43) Pub. Date: Jun. 25, 2026

(54) METHOD AND SYSTEM FOR ISSUING TOKENS AND PROVIDING TOKENIZED REWARDS

(71) Applicant: LIFE TOKEN SOFTWARE, INC., Cos Cob, CT (US)

(72) Inventor: Jeff Dyment, Cos Cob, CT (US)

(73) Assignee: LIFE TOKEN SOFTWARE, INC., Cos Cob, CT (US)

(21) Appl. No.: 18/780,406

(22) PCT Filed: Jan. 19, 2023
(86) PCT No.: PCT/US2023/060924

§ 371 Date: Jul. 22, 2024

Related U.S. Application Data
(60) Provisional application No. 63/266,835, filed on Jan. 15, 2022.

(51) Int. Cl. G06Q 30/02; G06Q 20/38; G06Q 30/0241

(52) U.S. Cl. CPC G06Q 30/02; G06Q 20/387; G06Q 30/0277

(57) ABSTRACT

A method and system for dynamically managing participation in one or more events has a participation cloud platform that connects to a plurality of event initiators and event participators. An event initiator uses the participation cloud platform to initiate an event for event participators, and a smart contract is used to settle a transaction in which the event initiator provides reward tokens to one or more event participators.

### CROSS-REFERENCE TO RELATED APPLICATION

This application is a continuation of International Patent Application No. PCT/US23/60924, filed on Jan. 19, 2023 claims the benefit of U.S. Provisional Patent Application No. 63/266,935, filed Jan. 19, 2022, titled METHOD AND SYSTEM FOR ISSUING TOKENS AND PROVIDING TOKENIZED REWARDS, each of which is incorporated by reference herein in its entirety.

### TECHNICAL FIELD

This application generally relates to systems and methods for issuing and using tokens for rewards/incentive programs and to tokenized reward programs. This application also relates to methods and systems for providing secure transferable rewards/incentives using blockchain and cryptocurrencies to provide transferrable value rewards and incentives.

### BACKGROUND

The bitcoin system was developed to allow electronic cash to be transferred directly from one party to another without going through a financial institution, as described in the white paper entitled “Bitcoin: A Peer-to-Peer Electronic Cash System” by Satoshi Nakamoto. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner, as represented by the new owner public key. The signing by the owner of the bitcoin is an authorization by the owner to transfer ownership of the bitcoin to the new owner via the new transaction. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To help ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network has a complete replica of the entire blockchain. The bitcoin system also implements techniques to ensure that each node will store the identical blockchain, even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created. A bitcoin ledger is sometimes referred to as an Unspent Transaction Output (“UTXO”) set because it tracks the output of all transactions that have not yet been spent.

Although the bitcoin system has been very successful, it is limited to transactions in bitcoins or other cryptocurrencies. Efforts are currently underway to use blockchains to support transactions of any type, such as those relating to the sale of vehicles, sale of financial derivatives, sale of stock, payments on contracts, and so on. Such transactions use identity tokens, which are also referred to as digital bearer bonds, to uniquely identify something that can be owned or can own other things. An identity token for a physical or digital asset is generated using a cryptographic one-way hash of information that uniquely identifies the asset. Tokens also have an owner that uses an additional public/private key pair. The owner public key is set as the token owner identity, and when performing actions against tokens, ownership proof is established by providing a signature generated by the owner private key and validated against the public key listed as the owner of the token. A person can be uniquely identified, for example, using a combination of a username, social security number, and biometric (e.g., fingerprint). A product (e.g., refrigerator) can be uniquely identified, for example, using the name of its manufacturer and its serial number. The identity tokens for each would be a cryptographic one-way hash of such combinations. The identity token for an entity (e.g., person or company) may be the public key of a public/private key pair, where the private key is held by the entity. Identity tokens can be used to identify people, institutions, commodities, contracts, computer code, equities, derivatives, bonds, insurance, loans, documents, and so on. Identity tokens can also be used to identify collections of assets. An identity token for a collection may be a cryptographic one-way hash of the digital tokens of the assets in the collection. The creation of an identity token for an asset in a blockchain establishes provenance of the asset, and the identity token can be used in transactions (e.g., buying, selling, insuring) involving the asset stored in a blockchain, creating a full audit trail of the transactions.

To record a simple transaction in a blockchain, each party and asset involved with the transaction needs an account that is identified by a digital token. For example, when one person wants to transfer a car to another person, the current owner and next owner create accounts, and the current owner also creates an account that is uniquely identified by the car's vehicle identification number. The account for the car identifies the current owner. The current owner creates a transaction against the account for the car that indicates that the transaction is a transfer of ownership, indicates the public keys (i.e., identity tokens) of the current owner and the next owner, and indicates the identity token of the car. The transaction is signed by the private key of the current owner, and the transaction is evidence that the next owner is now the current owner.

To enable more complex transactions than bitcoin can support, some systems use “smart contracts.” A smart contract is computer code that implements transactions of a contract. The computer code may be executed in a secure platform (e.g., an Ethereum platform, which provides a virtual machine) that supports recording transactions in blockchains. Alternatively, the computer code representing the smart contract may be executed in a software program embedded in a blockchain (e.g., a Tendermint platform) that supports recording transactions and information in blockchains. In addition, the smart contract itself is recorded as a transaction in the blockchain using an identity token that is a hash (i.e., identity token) of the computer code so that the computer code that is executed can be authenticated. When deployed, a constructor of the smart contract executes, initializing the smart contract and its state. The state of a smart contract is stored persistently in the blockchain. When a transaction is recorded against a smart contract, a message is sent to the smart contract, and the computer code of the smart contract executes to implement the transaction (e.g., debit a certain amount from the balance of an account). The computer code ensures that all the terms of the contract are complied with before the transaction is recorded in the blockchain. For example, a smart contract may support the sale of an asset. The inputs to a smart contract to sell a car may be the identity tokens of the seller, the buyer, and the car and the sale price in U.S. dollars. The computer code ensures that the seller is the current owner of the car and that the buyer has sufficient funds in their account. The computer code then records a transaction that transfers the ownership of the car to the buyer and a transaction that transfers the sale price from the buyer's account to the seller's account. If the seller's account is in U.S. dollars and the buyer's account is in Canadian dollars, the computer code may retrieve a currency exchange rate, determine how many Canadian dollars the seller's account should be debited, and record the exchange rate. If either transaction is not successful, neither transaction is recorded.

When a message is sent to a smart contract to record a transaction, the message is sent to each node that maintains a replica of the blockchain. Each node executes the computer code of the smart contract to implement the transaction. For example, if 100 nodes each maintain a replica of a blockchain, then the computer code executes at each of the 100 nodes. When a node completes execution of the computer code, the result of the transaction is recorded in the blockchain. The nodes employ a consensus algorithm to decide which transactions to keep and which transactions to discard. Although the execution of the computer code at each node helps ensure the authenticity of the blockchain, it requires large amounts of computer resources to support such redundant execution of computer code.

Purchase transactions between retailers (or merchants) and purchasers (or customers) are typically paid for with credit cards. Credit card purchases, however, are particularly vulnerable to fraud. Any person with access to credit card (e.g., a stolen credit card) for in-store purchases or credit card information (e.g., purchased on the web) for online purchases can make a purchase without the approval of the credit card holder. Although consumer protection laws may provide some degree of protection for the credit card holder (assuming the fraud is noticed), the credit card company may be liable for the fraudulent purchase. To help prevent such fraudulent purchases, a credit card company may employ extensive fraud protection mechanism. For example, if a purchase is made at a retailer in a geographic area in which the credit card holder does not normally use the credit card (e.g., a different country), the credit card company may put a fraud alert on the account and decline the purchase transaction. To remove a fraud alert, a credit card holder may need to contact the credit card company, provide the necessary credentials, prove that the transaction is not fraudulent, and again attempt to make the purchase. The time needed to remove the fraud alert can present problems for various types of purchases such as a purchase for a ticket on a train or plane that is about to depart, for a toll road, and so on.

Social networks are internet applications or platforms which enable communities of individuals and businesses to create content in the form of video, photographic, or text messages and communally interact with that content. To the extent that marketplaces exist on these social networks, they typically take the form of retailers and purchasers as described above or as a clearinghouse facilitating retailers and purchasers akin to an online shopping mall. The distinction between social content and marketplaces on social networks is notable, as is the lack of overlap between social content and participatory, reward-based interaction with that content.

### SUMMARY

One aspect of this application is a method performed by one or more computers having a processor and memory for dynamically managing participation in one or more events. The method can have the step of operating a participation cloud platform (e.g., by a third-party or host) connected to a plurality of event initiators and event participators, and the participation cloud platform provides reward token processing on behalf of the plurality of event participators and event initiators. Events can include requests to participate or undertake certain tasks, call-to-actions, online or offline events, perform some function or not perform some function, “like” “comment” or “share” something posted on social media channels, watch, download, participate, provide work product, perform any type of function requiring human energy, cerebral energy or sharing of physical resources, purchasing something, referral programs, sales campaigns, affiliate campaigns, or anything imagined by the event initiator typically surrounding growing or engaging material audiences. Event initiators are those who set up and start events and event participators are those who participate or complete events (e.g., those set up by an initiator). The participation cloud platform can receive information from an event initiator or multiple event initiators using the participation cloud platform regarding event initiation (e.g., the nature of the event, the amount of the reward, the parameters defining completion of the event, the desired characteristic of an event participator.) The event can be made private, whereas the Event can be reserved to those invited only and is not visible to the general public using the platform, or it can be marked public, which would make the event visible to all users. An event may be indicated as an offer the reward token for completing the requested task, or be marked to accept the token back from users in exchange for products or services. In such cases where the event initiator is accepting reward tokens back in exchange for products, services or access, the event initiator can reuse those reward tokens for other new events once the initial transaction is settled. A smart contract is initiated to settle a transaction in which an event participator provides reward tokens to a defined number of event participators for completing the event and the event initiator escrows reward tokens in such quantity to satisfy providing the one or more event participators with the reward tokens. The platform allows for a stable reward system. The event is published by the participation cloud platform by joining the elements of the event and the smart contract to manage event participation. Event participators can then join or review the event and make decisions accordingly. The platform can receive and manage the enrollment requests from the one or more event participators for the event. The platform can then determine whether the event has been completed by the participators and can notify the event initiators of such completion or the status of completion. Ultimately, the platform can provide reward tokens, effected through the smart contract, to the one or more event participators having the indications of the event completion through the participation cloud platform after verification of completion of the event by the one or more event initiators.

Another aspect includes the provision of reward tokens to event participators settled using the smart contract and the participation cloud platform effects depositing of the reward token to a wallet controlled by the one or more event participators.

Another aspect includes the event being initiated using an event management guardian that confirms that the event initiator has sufficient reward tokens escrowed with the participation cloud platform to settle the transaction.

Another aspect includes verifying event completion by receipt of a displayed QR code provided upon the event completion to the event participator, wherein the QR code, when scanned by the event participator, verifies event completion.

Another aspect includes the transaction being completed using proof of the event completion received from a payment terminal. For example, the payment terminal can show that the event participator paid for the event, which may complete the event.

Another aspect includes determining a transaction is completed by using proof of the event completion received by the event participator from a POS terminal.

Another aspect includes determining the transaction is completed using proof of the event completion received from a third-party API, as an e-commerce platform, an LMS platform, or a banking platform.

Another aspect includes the event completion initiated by a third-party on behalf of the event initiator. A third party can help evo organize events and get event participator to partaken in the same.

Another aspect includes allowing the event completion to be shown by the initiator themselves, using a manual or automatic verification of completion.

Another aspect includes transaction settlement managed by the participation cloud platform in an automatic fashion through presentation of definitive proof.

Another aspect includes publishing the event at a provided time after the event is created through a scheduler inside the EMG.

Another aspect includes allowing the event participators to be selected based on transaction information, participation criteria, and payment information.

Another aspect includes inviting unknown users to create a new single sign-on ID usable to authenticate to utilize the participation cloud platform.

Another aspect includes converting the reward token to a digital currency token.

Another aspect includes inviting unknown users to become event participators or event initiators and to create an ID to authenticate and use the participation cloud platform.

Another aspect includes the participation cloud platform providing recommendations for the event to the one or more event participators.

Another aspect includes a system to execute a participation cloud platform, wherein the system comprises: a memory to store instructions; a processor to execute instructions to execute the participation cloud platform (e.g., by a host or third-party) on behalf of a plurality of event initiators and event participators. The participation cloud platform provides reward token processing on behalf of the plurality of event participators and event initiators. The system executes a smart contract to settle a transaction in which one or more event participators are provided with reward tokens for completing the event and the event initiator escrow tokens in such quantity to satisfy providing the one or more event participators with the reward tokens. The participation cloud platform allocates reward tokens to the one or more event participators that completed the event. A first interface allows an event initiator to initiate the event and a second interface allows an event participator to participate and obtain or show event completion. The participation cloud platform allocates the rewards tokens to the event participator upon event completion using the smart contract.

Another aspect includes a method for issuing reward tokens for a reward program, comprising: monitoring the participation of event participators using a participation cloud platform connected to a plurality of event initiators and event participators, wherein the participation cloud platform provides reward token processing on behalf of the plurality of event participators and event initiators to determine whether the participator engages in a preferred behavior; awarding the reward token based on the preferred behavior of the event participator, wherein the reward token is awarded using a smart contract, wherein the smart contract settles a transaction in which an event initiator provides reward tokens to a defined number of event participators for completing event and the event initiator escrows reward tokens in such quantity to satisfy providing the one or more event participators with the reward tokens; and providing the reward token to an electronic wallet of the event participator.

Another aspect includes the event participator able to use the reward tokens for their own audience engagement activities in the same marketplace from which they earned them.

Another aspect includes the event participator able to use reward tokens for purchases, discounts, and other self-benefiting activities, to stake their tokens, or to exchange their tokens for other compatible tokens, USD, or other assets marketed on the token exchange.

Another aspect includes associating the reward tokens with a unique payment rewards identifier value.

### BRIEF DESCRIPTION OF THE DRAWINGS

FIG. 1 shows an exemplary architecture, including an exemplary participation cloud platform, in accordance with specific embodiments;

FIG. 2 illustrates aspects of an exemplary participation cloud platform (e.g., a SRN system) that allows event participators (e.g., consumers) and event initiators (e.g., corporations) to initiate and manage events;

FIG. 3 shows exemplary methodology of a smart contract application in accordance with specific embodiments;

FIG. 4 illustrates the basic and illustrative system after an event has been published by the participation cloud platform;

FIG. 5 shows a flow diagram illustrating an exemplary method for implementing reward token across a participation cloud platform in accordance with specific embodiments; and

FIG. 6 is an architecture diagram that illustrates systems and entities participating in the SRN or participation cloud platform.

### DETAILED DESCRIPTION

This application is directed to reward programs for providing transferable rewards using blockchain, cryptography, and cryptocurrencies (or the like) to provide transferrable value rewards.

As a preliminary matter, a “rewards program” as used herein may refer to, but not be limited to, a marketing strategy by merchants, employers, organizations, both online and offline groups, users etc. to encourage participants and audiences to engage in one or more behaviors associated with each program or engagement campaign.

In one embodiment, an internet-based marketplace or a participation cloud platform establishes an ecosystem that runs on a standardized “reward token” allowing users to be incentivized to promote one or more behaviors. In certain aspects, this application describes a solution to the problem of managing corporate rewards within a tokenized ecosystem. Employers, corporate entities, individuals (event initiators) may manage their rewards program utilizing their own infrastructure, while using a fungible token run by a third-party provider. This third-party can host the participation cloud platform. For example, employers may also integrate with a third party to run their reward programs. For example, one employer may manage their own rewards program by incentivizing its employees to take care of their health or adopt a preferred habit (e.g., wellness or social responsibility) and reward the employee's behavior with a number of tokenized rewards accrued by each employee. Having been earned by an employee or customer of one organization (event participator), the tokenized reward may be carried in a digital wallet by the earning party of one organization indefinitely, to be used in transactions or campaigns of another organization and/or may be exchanged on an exchange. The token or fungible token assist companies and their employers or customers or partners in creating and managing a cross-platform incentive system, which goes beyond just offering cash, equity incentives or proprietary rewards points. The token or fungible token assists social influencers, brands, organizations, communities and online and offline groups with their fans, followers and audience members in creating and managing a cross-platform incentive system. The token or fungible token is more beneficial to the participants and audience members to those who earn it than proprietary points systems given its ubiquitous nature, its potential to go up in value over time, its usability, and its transportability. The reward system can be managed through a smart contract feature, which allows for a more stable value.

In another embodiment, an internet-based marketplace or participation cloud platform (e.g., hosted by a third party) establishes an ecosystem that runs on a standardized “reward token” allowing users or event initiators to be incentivized to promote one or more behaviors. Employers, corporate entities may manage their rewards program utilizing their own reward infrastructure, while using a fungible token run by a third-party provider or the host organization. For example, one employer may manage their own rewards program by incentivizing its employees to take care of their health or adopt a preferred habit (e.g., wellness or social responsibility) and reward the employee's behavior with a number of tokenized rewards accrued by each employee. Again, the token or fungible token is more beneficial to the participants and audience members to those who earn it than proprietary points systems given its ubiquitous nature, its potential to go up in value over time, its usability, and its transportability.

Specific embodiments related to methods and systems for operating a participation cloud platform (e.g., by a host) on behalf of a plurality of event initiators, in which the platform provides at reward token or stable reward tokens on behalf of the plurality of event initiators (and/or event participators), allocating tokens to the event participators through the participation cloud platform; and confirming the completion or participation in the event by the event participator(s).

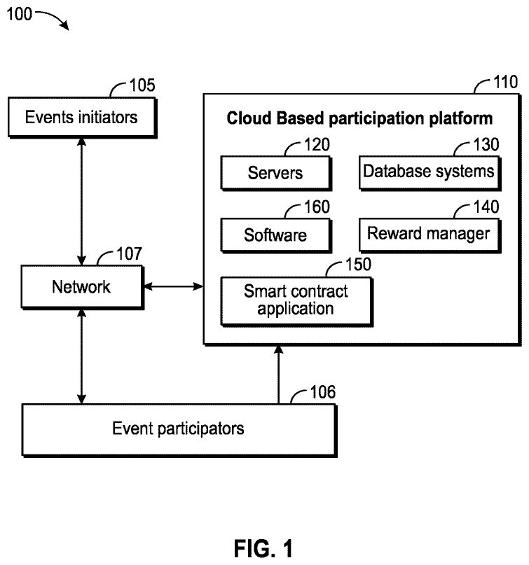

FIG. 1 shows an exemplary architecture 100 in accordance with specific embodiments. As shown, the participation cloud platform 110 is operatively connected with event initiators 105 and event participators 106 through a network 170. The event initiators and the event participators can be connected through one or more devices (e.g., mobile phones, tablets, PCs, and other devices). The cloud-based participation platform is connected to server(s) 120, databases (systems) 130, software 160, and processors. The participation cloud platform 110 has a reward manager 140 and a smart contract application 150 to help ensure reward tokens are given only to appropriate event participators 106 (e.g., upon completion of an event). The architecture 100 connects event initiator 105 and event participators 106 and can include authentication systems and features. In specific embodiments, the architecture 100 can receive information of or from an event initiator using the platform regarding the initialization an event, initiating a smart contract through the smart contact application 150 for the open event by receiving from an event initiator causing the event initiation, such information as is necessary to escrow tokens in such quantity as is required to satisfy transaction reward criteria provided by the event initiator (e.g., definite proof of completion), publishing the event to the participation cloud platform by joining the elements of the event and the smart contract managing event participation; processing indications of completion of event by the event participators, notifying and presenting a list of such indications of event completion to the event initiators initiating the event; and providing reward tokens to the event participator participation cloud platform by verification of completion from the event. The architecture 100 can facilitate requests and queries and can facilitate payment from event initiators 105 for reward tokens.

In one embodiment, a tokenized reward system is supported with an infrastructure for smart contracts to enforce participatory requirements with associated payment methodologies. In some embodiments, the framework of a network or social rewards network (“SRN”) system or participation cloud platform provides scalable support for a high number (potentially tens of millions) of transactions per second using blockchain technology such as Ethereum, Tendermint, or Algorand blockchain.

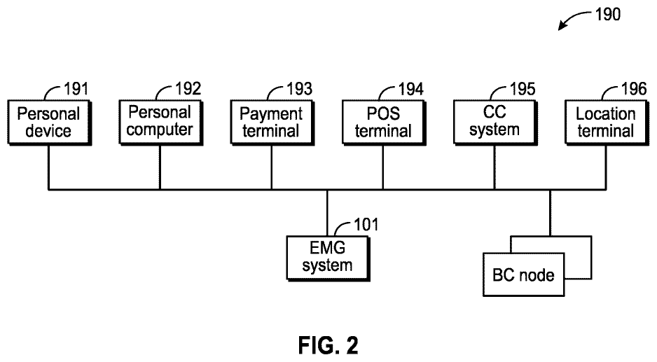

FIG. 2 illustrates aspects of an exemplary participation cloud platform (a SRN system) that allows consumers (event participators) and corporations (event initiators) to initiate and manage events with dynamically created milestones which cause secure payments of tokenized rewards to one or many other consumers and corporations using cryptocurrency wallets and tokenized rewards with the aid of consumer personal devices (e.g., smartphones) 191 or personal computers 192. The SRN system provides a common infrastructure for interfacing personal devices 191, personal computers 192, payment terminals (e.g., credit/debit card terminals) 193, point-of-sale (“POS”) 194 terminals, location terminals (e.g., geofencing systems and services) 196, credit card (“CC”) 195 systems, and an event management guardian (“EMG”) system 101 of the SRN system that supports a variety of definitive proof and participation management methodologies associated with a smart contract structure for managing and facilitating the event and associated participation. In addition to ensuring security and proof of participation, the EMG system enforces a user approval mechanism through which transactions require approval using the personal devices of the event initiator or, in the alternative, an agreed-upon method of definitive proof. The SRN system supports secure transmission of approval information using various encryption techniques such as asymmetric encryption (e.g., private/public keypair encryption) and/or symmetric encryption (e.g., Diffie-Hellman key exchange.) Thus, an event is defined by a series of milestones with associated proof of completion and commensurate tokenized rewards and is entered into the EMG system whereupon one or many consumers engage in the event through the SRN system and settlement is managed by the EMG system of the SRN system. Because of the efficiencies and security provided by the SRN system, consumer trust in performing tasks or otherwise participating in events is enhanced. Also, management of payment through settlement by tokenized rewards can be automated. The SRN system is described primarily in the context of social network systems and platforms. The SRN system may be used with other types of systems such as banking systems and debit or credit accounts, gift card accounts, loyalty accounts, line of credit accounts, and so on.

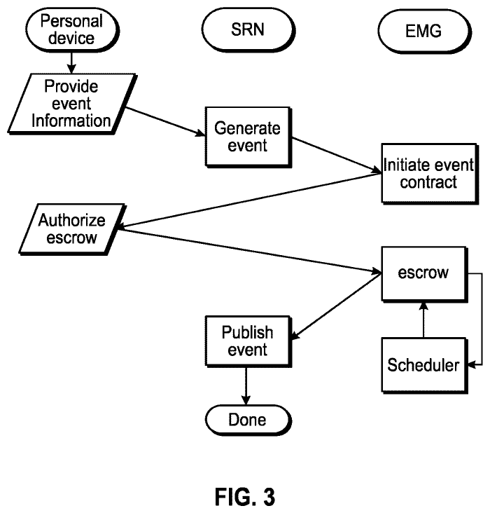

FIG. 3 illustrates the basic and illustrative system for managing smart contracts for use with the participation cloud platform. As shown, and event initiator enters or provides event information to the participation cloud platform, which then generates an event and initiates an event contract. An escrow is authorized for the amount of reward tokens and the event initiator provides or buys sufficient tokens to be escrowed for the event. In one example, the host of the participation cloud platform can take a percentage of the money paid to purchase the reward token. After the reward tokens are escrowed, the event is published on the participation cloud platform for potential event participators. The event is initiated when the event module escrows sufficient reward tokens from the event initiator's wallet (which may include dynamically minted reward tokens as described above), which the escrow being solely subject to the terms of the contract built around the various data elements. Once initiated, the event proceeds through various states. This progression in turn may allow other unknown participators or outside user(s) to participate in the event. After an event is completed by an event participator, the reward token is taken from escrow and transferred to the event participator's wallet.

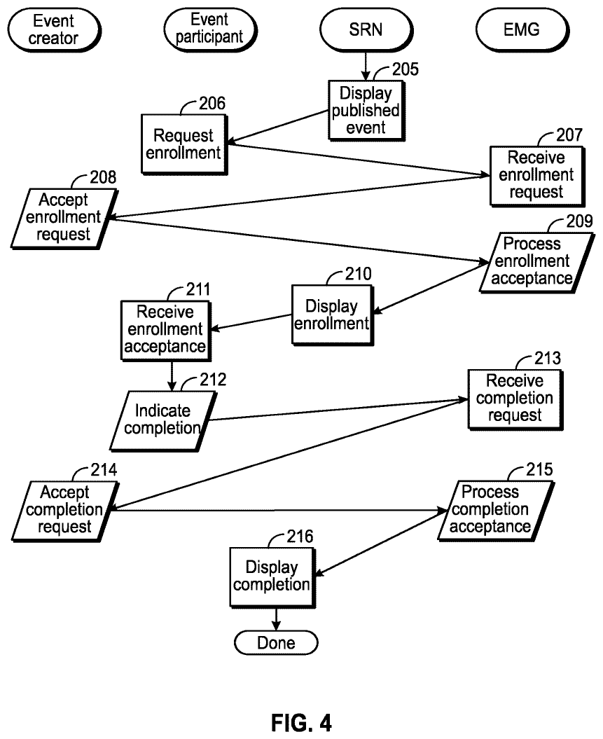

FIG. 4 illustrates the basic and illustrative system after an event has been published by the participation cloud platform. After the event is published 205, enrollment requests 207 of event participators can begin. The event initiator can accept or reject the enrollment requests 208 and then the system can process the requests or tell the event participators of acceptance 209. The enrollment details can be displayed 210 and conveyed to the event initiator 211. After the event is completed 214, the system indicates that the event participator has completed the event and the completion is verified/processed 215. The completion is displayed to the event initiator and the event participator is given reward tokens.

The event smart contract can dynamically create an event when an event initiator provides the event smart contract sufficient information to cause event creation. An event is initiated when a participation cloud platform user provides inputs for the event module on the participation cloud platform through the participation cloud platform front-end or first interface (e.g., a mobile app, computer application, website, wearable device interface, or the like.) This user is termed the event initiator for the purposes of this treatment. The event initiator provides the following data elements to initiate an event: CreatorID (the Public Key address of the event initiator), CreatorPrivateKey (the Private Key of the event initiator, required for initial escrow of reward tokens), ParticipationUserLimit (the number of Users who can Participate in the Event), ParticipationRewardAmount (the amount of reward tokens to be rewarded to each event participator for Participating), StartDate (the date and time the event initiator identifies for the start of their event), and EndDate (the date and time the event initiator identifies for the end of their event.)

In one embodiment, a series of oracles are used to gather various additional data elements for the smart contract to successfully complete its task: ClosedWindow (the time between an Event being Ended and being Closed), and OverheadMinting (the amount of overhead minted for each Settlement, written as a percentage of the Settlement amount.) In some embodiments, the event module on the participation cloud platform may dynamically mints reward tokens to meet the OverheadMinting cost; in other embodiments, the costs are added to the event initiator's escrowed reward token requirement. As such, the event module on the participation cloud platform then calculates EscrowedReward (the total reward token to be escrowed.)

In some embodiments, the SRN system or participation cloud platform employs wireless technology to support communications between personal devices, personal computers, payment terminals, POS terminals, location terminals, and the EMG system.

The benefits of the blockchain are innumerable, but most importantly is that the blockchain creates an immutable record of each transaction and transfer that cannot be altered or removed by an attacker, hack or centralized governing authority. The token system can have interoperability across other blockchains. Useable on Cosmos IBC by swapping into other IBC tokens using bridges, but also will be usable and swappable into other blockchain's native currencies such as ETH, DOT, BTC and thousands of other crypto currencies.

The third-party software provider may administer a rewards management application that can associate tokens with a participant's rewards account. In the example embodiment, the rewards management application associates the preferred or incentive activity with one or more tokens generated by a token generation program. The token may be stored in a wallet, which may be accessible by one or more merchants.

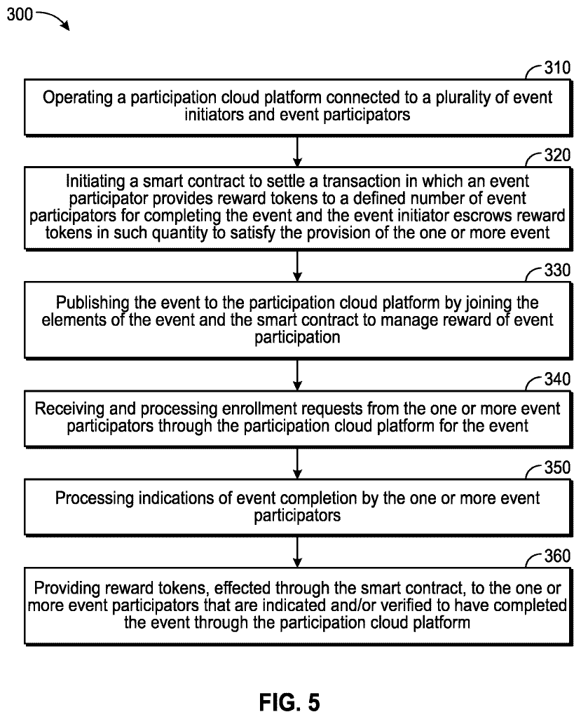

FIG. 5 shows an exemplary embodiment that is a method performed by one or more computers having a processor and memory for dynamically managing participation (e.g., by a third-party host) in one or more events. The method 300 has the steps of operating a participation cloud platform connected to a plurality of event initiators and event participators 310. The participation cloud platform provides reward token processing on behalf of the plurality of event participators and event initiators. In some examples, the event initiator or the event participator may buy or purchase reward tokens. The information from an event initiator is use by the participation cloud platform to initiate an event. That information can publish through the platform. A smart contract is used to settle a transaction in which an event participator provides reward tokens to a defined number of event participators for completing the event and the event initiator escrows reward tokens in such quantity to satisfy providing the one or more event participators with the reward tokens 320. The event can be published to inform participants 330 and enrollment in the events can be managed accordingly 340. The platform can monitor or mark those event participators that have completed the event 350. Reward tokens, effected through the smart contract, are awarded to the one or more event participators having the indications of the event completion through the participation cloud platform after verification of completion from the event by the one or more event participators 360.

In one illustrative example, an event initiator may be a restaurant trying promote its grand opening. The event initiator may buy a set of reward tokens through the platform (operated by a host), and may set up the grand opening and the people the event initiator desires to attend the event. The event initiator may determine the number of tokens given to each participator to attend the event. After which a smart contact in initiated in which a number of tokens will be given to each person or event participator that attends the event. The event is published on the platform. The event participators that attend the event are deemed to have completed the event (which may be verified) and are given the number of reward tokens. The reward tokens may be used by the participants for their own audience engagement posts, may be exchanged for goods and services on the platform, may be gifted, used as tips, or may be exchanged for other value off-platform.

In another illustrative example, a brand holder (company, content creator, social influencer) may wish to use the platform to engage key or desired audiences between purchases, and posts a call-to-action on the platform which is to watch a video, attend an online event such as a webinar, or to like, comment or share one of the brands social media posts. After registering and being accepted into the micro-event, the participants who performed the requested task(s) are rewarded with the token.

In another illustrative example, a brand holder wishes to accept reward tokens for unloading excess inventory it will be burning at the end of a season. A post is made that will offer the opportunity to “Spend” a user's reward token with the brand in exchange for something physical, digital or attendance. The user goes through a similar registration process with the initiator with the completion resulting in the reward tokens reversing course and moving from a participant wallet to an event initiator wallet.

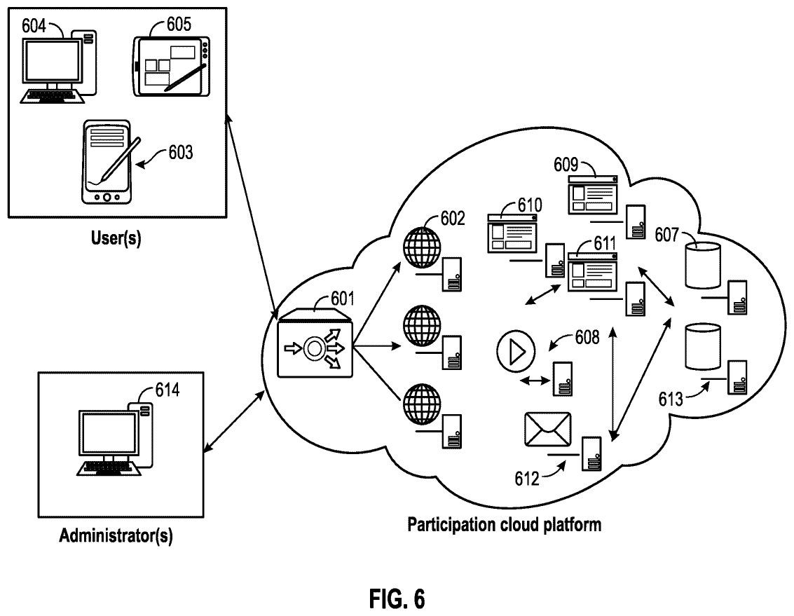

FIG. 6 is an architecture diagram that illustrates systems and entities participating in the SRN or participation cloud platform. The SRN system includes a computer front-end 601 that interfaces through an event management guardian (EMG) system 602 with user personal devices 603, point-of-sale terminals 604, payment terminals 605, location terminals, and credit card systems. The personal devices, point-of-sale terminals, payment terminals, location terminals, and credit card systems may include payment applications that are part of the SRN system. The SRN system records user-provided information, derived participation information, and various other information in a graph database system 607, media system 608, computer processing system 609, identity management system 610, settlement system 611, and notification system 612. The EMG system manages various transactions in a blockchain 613. The information and transactions relate to event status, event management, reward settlement transactions, reward token creation transactions, and so on.

In one embodiment, the event participator may use the reward tokens to participate in an event. For example, the event participator may use a number of reward tokens to pay to participate in the event. In one illustrative example, an event participator may need to pay a specific amount of reward tokens to attend the opening of an exclusive restaurant.

In another embodiment, the method and system can be used to measure the success of each activity at real-time focusing on the engagement levels and tokens earned per category to continuously highlight what's working and what is not so that the program always feature the highest value activities.

In another embodiment, the method and system can allow merchants, companies, employers and the like to provide points to participants that can be converted into reward tokens. These reward tokens may then be exchanged for goods, services, currencies, or the like.

In another embodiment, the method and system can allow participants to exchange their reward tokens to loyalty points or proprietary digital rewards offered by the brand, company, or event initiator, much like the spend feature referred to above. This exchange of reward token for points is recorded on the blockchain with the participant spending their reward token in exchange for the other asset (points, rewards, miles) offered by the event initiator.

In another embodiment, the method and system can provide merchants, companies, employers and the like with private labeled points or tokens. The points or tokens can be defined or set to convert into one or more exchangeable tokens. For example, the points can be converted into actual cryptocurrency on a 1:1 basis by the user or at a predetermined exchange ratio. This embodiment allows a sponsor (merchant, employer, company or the like) to provide participants or customer with the ultimate choice of what they want to do with the points, whether it is swap them for the native token, reuse them in the marketplace or exchange them for another benefit/reward offered by the sponsor of the transaction such as a free t-shirt, a discount on a product or service, or other corporate benefits such as extra time off. Once converted to allowable exchangeable currency, they can then swap, stake, exchange, or monetize into other tokens or currencies on third-party exchanges.

Although the native token may initially be the digital property available to be earned or converted into, it is expected that over time, other cryptocurrencies and/or tokens will be made available to the network participants to be earned by participants directly from sponsors and creators or to be swapped into via an off-chain and on-chain transaction.

One advantage is the system allows for a ubiquitous interoperable rewards token. The token may be useable across various networks, brands, ecosystems, and companies. A token earned in one transaction from one sponsor or employer can then be immediately usable or swappable into other tokens, convertible into USD, swapped into other third-party fungible or non-fungible tokens, or reusable in the same marketplace to engage one's own audiences or used on a third-party exchange for other cryptographic tokenized transactions. Tokenized rewards can be permanent, durable, transferable, exchangeable, divisible, recognizable as a digital asset or digital property, freely tradable, portable, scarce, and inflation resistant.

In one example, the method and system can allow companies to create a customized program to encourage employees to engage in healthier lifestyles, engage in brand building exercises, or engage in other activities that stimulate the mind or body, improve the company in some way, benefit their community or benefit themselves in some way. To enhance the sense of accomplishment for certain tasks and to increase engagement, customers are given reward token to attach to the completion of each program transaction or campaign. An example of this is a company offers a “stop smoking” program posted as a transaction on the token's human capital exchange or marketplace. The sponsoring company then invites into the campaign all its employees who wish to stop smoking as well as any customers or followers of the brand. Once accepted into the campaign, the event participants then go about completing the program. In addition to having kicked a bad habit, each participator who completes the transaction receives reward tokens that can be transferred from the company's token wallet to the employee's wallet. Sometimes, the company's token wallet is a ‘representation’ of their token allocation and in those cases, the token is transferred from the master wallet directly to the wallet of the participant, with the appropriate allocation being debited the total amount of the transfer. The transfer of token to the participant wallets is permanent and the token becomes the participant's asset until they reuse it, trade it, spend it or exchange it.

The rewards system can include servers, employer servers, administrator servers, and computing devices, all interconnected via network.

The term “blockchain” (and variations such as cryptocurrency ledger, and the like) as utilized herein may be understood broadly to describe a cryptocurrency ledger that records, administrates or otherwise processes online transactions. A blockchain may be public, private, or a combination thereof, without limitation. A blockchain may also be used to represent a set of digital transactions, agreement, terms or other digital value. Without limitation to any other aspect or description of the present disclosure, in the former case, a blockchain may also be used in conjunction with investment applications, token-trading applications, and/or digital/cryptocurrency-based marketplaces. A blockchain can also be associated with rendering consideration, such as providing goods, services, items, fees, access to a restricted area or event, data or other valuable benefit. Blockchains in various forms may be included where discussing a unit of consideration, collateral, currency, cryptocurrency or any other form of value. One of skill in the art, having the benefit of the disclosure herein and knowledge ordinarily available about a contemplated system, can readily determine the value symbolized or represented by a blockchain. While specific examples of blockchains are described herein for purposes of illustration, any embodiment benefiting from the disclosures herein, and any considerations understood to one of skill in the art having the benefit of the disclosures herein, are specifically contemplated within the scope of the present disclosure.

The term smart contract services (and similar terms) as utilized herein should be understood broadly. Without limitation to any other aspect or description of the present disclosure, a smart contract service includes any service or application that manages a smart contract. For example, the smart contract service may specify terms and conditions of a smart contract, such as in a rules database, or process output from a set of valuation services and assign items of collateral sufficient to provide security for a loan. Smart contract services may automatically execute a set of rules or conditions that embody the smart contract, wherein the execution may be based on or take advantage of collected data. For example, smart contract services may automatically initiate a demand for payment of a loan, automatically initiate a foreclosure process, automatically initiate an action to claim substitute or backup collateral or transfer ownership of collateral, automatically initiate an inspection process, automatically change a payment or interest rate term that is based on the collateral, and may also configure smart contracts to automatically undertake a loan-related action. For example, a smart contract can be used to settle a transaction in which the event initiator provides reward tokens to a defined number of event participators for completing the event and manage the escrow of reward tokens in such quantity to satisfy providing the defined number of event participators with the reward tokens. Smart contracts may be agreements that are encoded as computer protocols and may facilitate, verify, or enforce the negotiation or performance of a smart contract. Smart contracts may or may not be one or more of partially or fully self-executing, or partially or fully self-enforcing.

An event initiator may a person or entity (user) or process that creates an event.

An event participator may a person or entity (user) that participates an event (e.g., an event set up by an event initiator).

In various embodiments, the methods can be implemented using the various machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

The computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

The computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, JBOSS). In various embodiments, the server may include web servers (e.g. APACHE, IIS, GWS, SUN JAVA® SYSTEM WEB SERVER).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®), and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

Practitioners will appreciate that a web client may or may not be in direct contact with an application server such as a digital wallet hub. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS®/CE/Mobile, OS2, UNIX®, LINUX®, SOLARIS®, MacOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction.

As used herein, “transmit” may include sending electronic data from one system component to another over a network connection. Additionally, as used herein, “data” may include encompassing information such as commands, queries, files, data for storage, and the like in digital or any other form.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE. RTM. Corporation (Redwood Shores, Calif.), MICROSOFT® Access® or MICROSOFT® SQL Server) by MICROSOFT®® Corporation (Redmond, Wash.). MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®ts, JAVASCRIPT, active server pages (ASP), common gateway interface scripts (CGI), extensible markup language (XML), dynamic HTML, cascading style sheets (CSS), AJAX (Asynchronous JAVASCRIPT And XML), helper applications, plug-ins, and the like. A server may include a web service that receives a request from a web server, the request including a URL and an IP address (123.56.192.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See. e.g., Alex Nghiem, IT Web Services: A Roadmap for the Enterprise (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT, VBScript, Macromedia Cold Fusion, COBOL, MICROSOFT® Active Server Pages, assembly, PERL, PHP, awk, Python, Go, Visual Basic, SQL Stored Procedures. PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The merchant computer and the bank computer may be interconnected via a second network, referred to as a payment network. The payment network which may be part of certain transactions represents existing proprietary networks that presently accommodate transactions for credit cards, debit cards, and other types of financial/banking cards. The payment network is a closed network that is assumed to be secure from eavesdroppers. Exemplary transaction networks may include the American Express® ApplePay®, GooglePay®, private networks (e.g., department store networks), and/or any other payment networks.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

Phrases and terms similar to “transaction account” may include any account that may be used to facilitate a financial transaction. Phrases and terms similar to “financial institution” or “account issuer” may include any entity that offers transaction account services. Although often referred to as a “financial institution,” the financial institution may represent any type of bank, lender or other type of account issuing institution, such as credit card companies, card sponsoring companies, or third party issuers under contract with financial institutions. It is further noted that other participants may be involved in some phases of the transaction, such as an intermediary settlement institution.

Although the disclosure includes a method, it is contemplated that it may be embodied as computer program instructions on a tangible computer-readable carrier, such as a magnetic or optical memory or a magnetic or optical disk.

1. A method performed by one or more computers having a processor and memory for dynamically managing participation in one or more events, the method comprising:
operating a participation cloud platform connected to a plurality of event initiators and event participators, wherein the participation cloud platform provides reward token processing on behalf of the plurality of event participators and event initiators;
receiving initiation information from an event initiator regarding the event through the participation cloud platform;
initiating a smart contract to settle a transaction in which the event initiator provides reward tokens to a defined number of event participators for completing the event and the event initiator escrows reward tokens in such quantity to satisfy providing the defined number of event participators with the reward tokens;
Publishing the event to the participation cloud platform by joining the elements of the event and the smart contract to manage reward of event participation;
processing enrollment requests for the event from the plurality of event participators through the participation cloud platform;
processing indications of event completion by the one or more event participators,
notifying the event initiator of the event completion; and
providing reward tokens, effected through the smart contact, to the one or more event participators that have the indications of event completion through the participation cloud platform.

2. The method of claim 1, wherein the provision of the reward token to the event participator is settled using the smart contract and the participation cloud platform effects depositing of the reward token to a wallet controlled by the one or more event participators.

3. The method of claim 1, wherein the event is initiated using an event management guardian that confirms that the event initiator has sufficient reward tokens escrowed with the participation cloud platform to settle the transaction.

4. The method of claim 1, wherein the event completion is verified by receipt of a displayed QR code provided upon the event completion to the event participator, and the QR code, when scanned by the event participator, verifies event completion.

5. The method of claim 1, wherein the transaction is completed using proof of the event completion received from a payment terminal.

6. The method of claim 1, wherein the transaction is completed using proof of the event completion received by the event participator from a POS terminal.

7. The method of claim 1, wherein the transaction is completed using proof of the event completion received from a third party API, as an e-commerce platform, an LMS platform, or a banking platform.

8. The method of claim 1, wherein the event completion is initiated by a third-party on behalf of the event initiator.

9. The method of claim 1, wherein the transaction is settled and managed by the participation cloud platform in an automatic fashion through presentation of definitive or defined proof of the event completion.

10. The method of claim 1, wherein the event is published at provided time after the event is created through a scheduler inside the participation cloud platform.

11. The method of claim 1, wherein event participators are selected based on transaction information, participation criteria, and payment information.

12. The method of claim 1, further comprising inviting unknown users to create a new single sign-on ID usable to authenticate with and use the participation cloud platform.

13. The method of claim 1, further comprising converting the reward token to a digital currency token.

14. The method of claim 1, wherein the participation cloud platform is operated by a host.

15. The method of claim 1, wherein the participation cloud platform recommends the event to the one or more event participators.

16. A system to execute a participation cloud platform, wherein the system comprises:
a memory to store instructions;
a processor to execute instructions to execute the participation cloud platform on behalf of a plurality of event initiators and event participators, wherein the participation cloud platform provides reward token processing on behalf of the plurality of event participators and event initiators, and a smart contract settles a transaction in which one or more event participators are provided with reward tokens for completing the event and the event initiator escrows tokens in such quantity to satisfy providing the one or more event participators with the reward tokens, wherein the participation cloud platform allocates reward tokens to the one or more event participators that completed the event;
a first interface to allows an event initiator to initiate the event.
a second interface that allows the event participator of the one or more event participators to participate and obtain proof of event completion;
wherein the participation cloud platform allocates the rewards tokens to the event participator upon event completion using the smart contract.

17. The system of claim 16, wherein the participation cloud platform invites unknown users to create a new single sign-on ID usable to authenticate with any one of the plurality of event initiators which utilize the participation cloud platform.

18. A method for issuing reward tokens for a reward program, comprising:
a. monitoring the participation of an event participator using a participation cloud platform connected to a plurality of event initiators and event participators, wherein the participation cloud platform provides reward token processing on behalf of the plurality of event participators and event initiators to determine whether the participator engages in a preferred behavior;
b. awarding the reward tokens based on the preferred behavior of the event participator, wherein the reward tokens are awarded using a smart contract, wherein the smart contract settles a transaction in which an event participator provides the reward tokens to a defined number of event participators for completing the event and the event initiator escrows the reward tokens in such quantity to satisfy providing the one or more event participators with the reward tokens; and
c. providing the reward tokens to an electronic wallet of the event participator.

19. The method of claim 18, wherein the event participator may use the reward tokens for their own audience engagement activities in the same marketplace from which they earned them.

20. The method of claim 18, wherein the event participator may use the reward tokens for purchases, discounts, and other self-benefiting activities, to stake their tokens, or to exchange their tokens for other compatible tokens, USD, or other assets marketed on the token exchange.

21. The method of claim 1, wherein each of the tokens is associated with a unique payment rewards identifier value.
